(19) United States
(12) Patent Application Publication
(10) Pub. No.: US 2024/0278516 A1
(43) Pub. Date: Aug. 22, 2024

(54) METHOD FOR PRODUCING PNEUMATIC TIRE

(71) Applicant: The Yokohama Rubber Co., Ltd., Kanagawa (JP)

(72) Inventors: Masahiro NARUSE, Kanagawa (JP); Takahisa MURATA, Kanagawa (JP)

(21) Appl. No.: 18/570,731

(22) PCT Filed: Jun. 13, 2022
(86) PCT No.: PCT/JP2022/023600

§ 371 Date: Dec. 15, 2023

(30) Foreign Application Priority Data
Jun. 22, 2021 (JP) 2021-103073

(51) Int. Cl. B29D 30/00

(52) U.S. Cl. CPC B29D 30/0061; B29D 2030/0083

(57) ABSTRACT

A method for producing a pneumatic tire is provided. A coating layer coating a transponder is caused to have, in a thickness direction thereof, a top surface layer located on a top surface side of the transponder and a back surface layer located on a back surface side of the transponder. A step is formed at least at an end portion on one side of both end portions of the coating layer in a width direction such that positions of end portions of the top surface layer and the back surface layer do not coincide with each other. The transponder coated with the coating layer having the step is embedded in an unvulcanized tire. The unvulcanized tire is vulcanized.

### TECHNICAL FIELD

The present technology relates to a method for producing a pneumatic tire for embedding a transponder coated with a coating layer and particularly relates to a method for producing a pneumatic tire that can suppress vulcanization defects of a tire.

### BACKGROUND ART

For pneumatic tires, embedding an RFID (radio frequency identification) tag (transponder) in a tire has been proposed (see, for example, Japan Unexamined Patent Publication No. H07-137510 A). When the transponder is coated with a coating layer and embedded in a tire, a gap is generated between the coating layer and a rubber member around the coating layer to cause vulcanization defects.

### SUMMARY

The present technology provides a method for producing a pneumatic tire that can suppress vulcanization defects of a tire.

A method for producing a pneumatic tire according to an embodiment of the present technology is a method for producing a pneumatic tire for embedding a transponder including: causing a coating layer coating the transponder to have, in a thickness direction thereof, a top surface layer located on a top surface side of the transponder and a back surface layer located on a back surface side of the transponder: forming a step at least at an end portion on one side of both end portions of the coating layer in a width direction such that positions of end portions of the top surface layer and the back surface layer do not coincide with each other: embedding the transponder coated with the coating layer having the step in an unvulcanized tire; and vulcanizing the unvulcanized tire.

In an embodiment of the present technology, causing the coating layer coating the transponder to have, in the thickness direction thereof, the top surface layer located on the top surface side of the transponder and the back surface layer located on the back surface side of the transponder, forming the step at least at the end portion on the one side of the both end portions of the coating layer in the width direction such that the positions of end portions of the top surface layer and the back surface layer do not coincide with each other, embedding the transponder coated with the coating layer having the step in an unvulcanized tire, and vulcanizing the unvulcanized tire allows a gap generated between the coating layer and a rubber member disposed adjacent to the coating layer to be reduced by the step. This can suppress vulcanization defects of the tire around the transponder.

In the method for producing a pneumatic tire according to an embodiment of the present technology, the step is preferably formed by shifting the positions of end portions of the top surface layer and the back surface layer at least at the end portion on the one side of both end portions of the coating layer in the width direction in sandwiching the transponder between the top surface layer and the back surface layer. This can effectively suppress vulcanization defects of the tire.

The step is preferably formed at each of both end portions in the width direction of the coating layer. This can effectively suppress vulcanization defects of the tire.

A width of the step preferably ranges from 1.5 mm to 5.0 mm. This can effectively suppress vulcanization defects of the tire and improve tire durability.

A thickness of at least one of the top surface layer or the back surface layer preferably ranges from 0.5 mm to 2.5 mm. This can effectively suppress vulcanization defects of the tire.

A relative dielectric constant of the coating layer is preferably lower than a relative dielectric constant of a rubber member disposed adjacent to the coating layer, and a total thickness Gac of the coating layer and a maximum thickness Gar of the transponder preferably satisfy a relationship 1.1≤Gac/Gar ≤3.0. This sufficiently separates the transponder from the adjacent rubber member and wraps the transponder with the coating layer having a low relative dielectric constant, thus allowing communication performance of the transponder to be improved. Further, specifying the upper limit value of the total thickness Gac of the coating layer with respect to the maximum thickness Gar of the transponder can ensure sufficient durability of the tire.

The coating layer is preferably made of elastomer or rubber and preferably has a relative dielectric constant of 7 or less. This enables the transponder to have a radio wave transmitting property, effectively improving the communication performance of the transponder.

Mooney viscosity of the coating layer is preferably lower than Mooney viscosity of a rubber member disposed adjacent to the coating layer. This makes the rubber flow of the coating layer during vulcanization satisfactory and causes vulcanization defects to be less likely to occur even when a gap is generated between the coating layer and the adjacent rubber member.

A minimum value M_{Lc} on a vulcanization curve obtained from torque detection by using a rheometer in the coating layer is preferably lower than a minimum value M_{Lt} on a vulcanization curve obtained from torque detection by using the rheometer in a rubber member disposed adjacent to the coating layer. This makes the rubber flow of the coating layer during vulcanization satisfactory and causes a gap to be less likely to be generated between the coating layer and the adjacent rubber member, thus allowing vulcanization defects of the tire to be effectively suppressed.

The transponder is preferably disposed such that a longitudinal direction of the transponder is within a range of ±10° with respect to a circumferential direction of a forming drum. This can effectively improve tire durability.

The center of the transponder is preferably disposed 10 mm or more away from a splice portion of a tire component in the tire circumferential direction. This can effectively improve tire durability.

The transponder is preferably disposed between a position 15 mm on an outer side in a tire radial direction from an upper end of a bead core of a bead portion and a position 5 mm on an inner side in the tire radial direction from an end of a belt layer. This causes metal interference to be less likely to occur and can have the communication performance of the transponder.

### BRIEF DESCRIPTION OF DRAWINGS

FIG. 1 is a meridian cross-sectional view illustrating an example of a pneumatic tire to which a method for producing a pneumatic tire according to an embodiment of the present technology is applied.

FIG. 2 is a cross-sectional view illustrating a main part of the pneumatic tire of FIG. 1.

FIGS. 3A and 3B are perspective views illustrating a transponder that can be embedded in the pneumatic tire of FIG. 1.

FIGS. 4A and 4B illustrate the transponder coated with a coating layer,

FIG. 4A is a perspective view, and FIG. 4B is a cross-sectional view.

FIGS. 5A and 5B are perspective views each illustrating a forming process of forming a step of the coating layer in the method for producing a pneumatic tire according to an embodiment of the present technology.

FIGS. 6A and 6B are explanatory diagrams illustrating a forming process in the method for producing a pneumatic tire according to an embodiment of the present technology.

FIG. 7 is a cross-sectional view illustrating the transponder coated with the coating layer and embedded in the pneumatic tire.

FIG. 8 is a meridian cross-sectional view schematically illustrating the pneumatic tire of FIG. 1.

FIG. 9 is an equator line cross-sectional view schematically illustrating the pneumatic tire of FIG. 1.

FIG. 10 is a cross-sectional view illustrating a main part of a modified example of the pneumatic tire to which the method for producing a pneumatic tire according to an embodiment of the present technology is applied.

FIGS. 11A to 11H each illustrate a modified example of the shape of the coating layer, FIGS. 11A to 11E are cross-sectional views, and FIGS. 11F to 11H are plan views.

FIG. 12 is an explanatory diagram illustrating the position of a transponder in a tire radial direction in a test tire.

### DETAILED DESCRIPTION

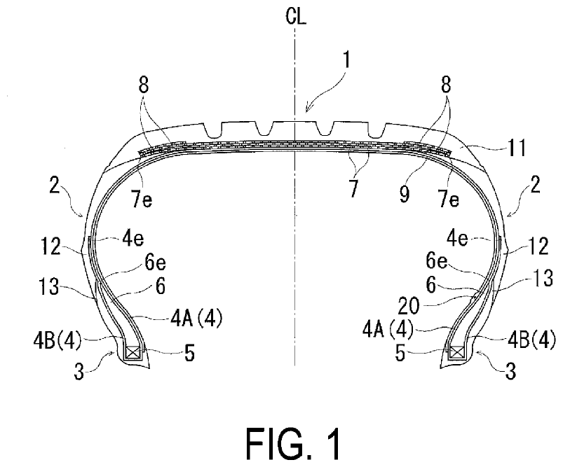

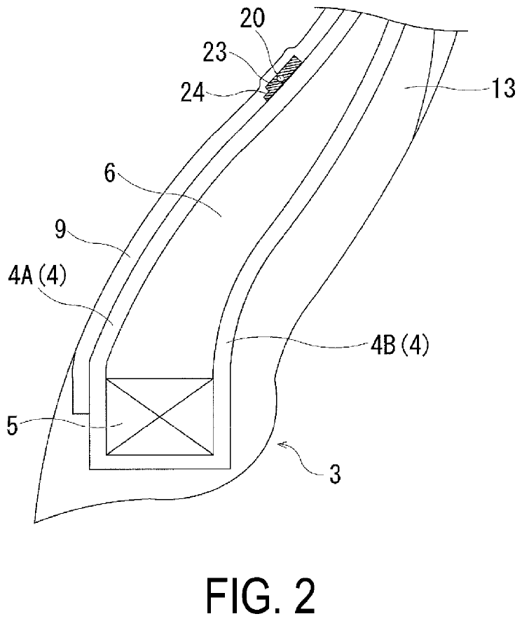

Configurations of embodiments of the present technology will be described in detail below with reference to the accompanying drawings. FIGS. 1 and 2 illustrate a pneumatic tire to which a method for producing a pneumatic tire according to an embodiment of the present technology is applied.

As illustrated in FIG. 1, the pneumatic tire according to the present embodiment includes a tread portion 1 extending in a tire circumferential direction and having an annular shape, a pair of sidewall portions 2 disposed on respective both sides of the tread portion 1, and a pair of bead portions 3 each disposed on an inner side of the pair of sidewall portions 2 in a tire radial direction.

At least one carcass layer 4 (one layer in FIG. 1) formed by arranging a plurality of carcass cords in the radial direction is mounted between the pair of bead portions 3. The carcass layer 4 is covered with rubber. Organic fiber cords such as nylon and polyester are preferably used as the carcass cord constituting the carcass layer 4. Bead cores 5 having an annular shape are embedded within the bead portions 3, and bead fillers 6 made of a rubber composition and having a triangular cross-section are disposed on the outer peripheries of the bead cores 5.

On the other hand, a plurality of belt layers 7 (two layers in FIG. 1) are embedded on a tire outer circumferential side of the carcass layer 4 of the tread portion 1. The belt layers 7 include a plurality of reinforcing cords that are inclined with respect to the tire circumferential direction, and the reinforcing cords are disposed between layers so as to intersect each other. In the belt layers 7, the inclination angle of the reinforcing cords with respect to the tire circumferential direction is set to fall in a range from 10° to 40°, for example. Steel cords are preferably used as the reinforcing cords of the belt layers 7.

To improve high-speed durability, at least one belt cover layer 8 (two layers in FIG. 1) formed by arranging reinforcing cords at an angle of, for example, 5° or less with respect to the tire circumferential direction is disposed on a tire outer circumferential side of the belt layers 7. In FIG. 1, the belt cover layer 8 located on the inner side in the tire radial direction constitutes a full cover that covers the entire width of the belt layers 7, and the belt cover layer 8 located on an outer side in the tire radial direction constitutes an edge cover layer that covers only end portions of the belt layers 7. Organic fiber cords such as nylon and aramid are preferably used as the reinforcing cords of the belt cover layer 8.

In the pneumatic tire described above, both ends 4e of the carcass layer 4 are folded back from the tire inner side to the tire outer side around the bead cores 5 and are disposed wrapping around the bead cores 5 and the bead fillers 6. The carcass layer 4 includes a body portion 4A corresponding to a portion extending from the tread portion 1 through each of the sidewall portions 2 to each of the bead portions 3 and a turned-up portion 4B corresponding to a portion turned up around the bead core 5 at each of the bead portions 3 and extending toward each sidewall portion 2 side.

An innerliner layer 9 is disposed along the carcass layer 4 on a tire inner surface. Furthermore, a cap tread rubber layer 11 is disposed in the tread portion 1, a sidewall rubber layer 12 is disposed in the sidewall portion 2, and a rim cushion rubber layer 13 is disposed in the bead portion 3.

In the pneumatic tire described above, the transponder 20 is embedded between the carcass layer 4 and the innerliner layer 9. As illustrated in FIG. 2, the transponder 20 is coated with a coating layer 23. The coating layer 23 coats the entire transponder 20 while sandwiching both top and back surfaces of the transponder 20.

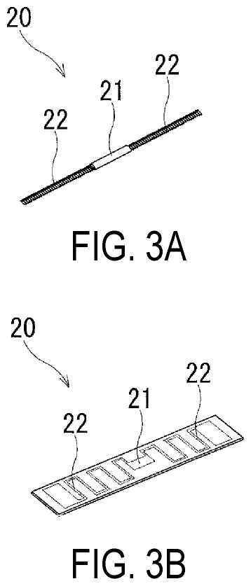

As the transponder 20, for example, a radio frequency identification (RFID) tag can be used. As illustrated in FIGS. 3A and 3B, the transponder 20 includes an IC (integrated circuit) substrate 21 that stores data and antennas 22 that transmit and receive data in a non-contact manner. Using such a transponder 20 allows information related to the tire to be written or read on a timely basis and the tire to be efficiently managed. The “RFID” refers to an automatic recognition technology including: a reader/writer including an antenna and a controller; and an ID (identification) tag including an IC substrate and an antenna, the automatic recognition technology allowing data to be communicated in a wireless manner.

The overall shape of the transponder 20 is not limited to particular shapes and can use a pillar- or plate-like shape as illustrated in, for example, FIGS. 3A and 3B. In particular, using the transponder 20 having a pillar-like shape illustrated in FIG. 3A can suitably follow the deformation of the tire in each direction. In this case, the antenna 22 of the transponder 20 projects from each of both end portions of the IC substrate 21 and exhibits a helical shape. This allows the transponder 20 to follow the deformation of the tire during traveling, allowing the durability of the transponder 20 to be improved. Additionally, appropriately changing the length of the antenna 22 can have the communication performance.

In an example illustrated in the embodiment of FIG. 1, the end 4e of the turned-up portion 4B of the carcass layer 4 is disposed in the middle of the sidewall portion 2, but no such limitation is intended. The end 4e of the turned—up portion 4B of the carcass layer 4 can be disposed at any height. For example, the end 4e of the turned-up portion 4B of the carcass layer 4 may be disposed on a side of the bead core 5.

Next, a method for producing a pneumatic tire according to an embodiment of the present technology will be described. In producing the pneumatic tire as described above, the pneumatic tire is produced by placing the innerliner layer 9 on a forming drum, layering thereon the transponder 20 coated with the coating layer 23 and tire components including the carcass layer 4, the bead core 5, the bead filler 6, the belt layer 7, and the belt cover layer 8, bonding the cap tread rubber layer 11, the sidewall rubber layer 12, and the rim cushion rubber layer 13 to form an unvulcanized tire, and vulcanizing the unvulcanized tire.

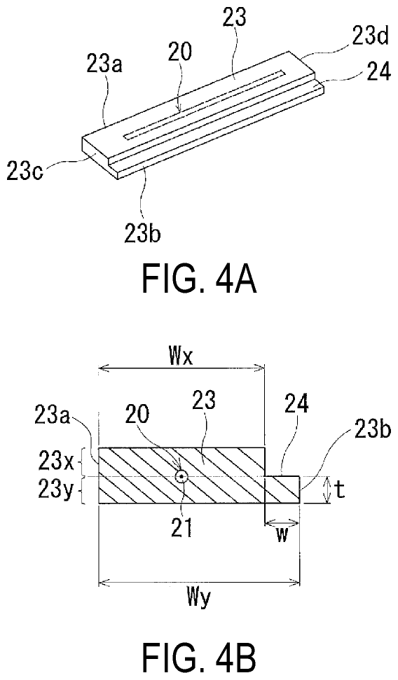

In such a producing process, a forming step of forming a step 24 in the coating layer 23 coating both the top and back surfaces of the transponder 20 is performed in advance. In the forming process, as illustrated in FIGS. 4A and 4B, the step 24 is formed such that the end positions at least on one side of both end portions 23a and 23b in the width direction of the coating layer 23 do not coincide on both surfaces of the coating layer 23. In FIGS. 4A and 4B, the step 24 is formed only at the end portion 23b in the width direction of the coating layer 23. Here, the coating layer 23 includes, in the thickness direction, a top surface layer 23x located on the top surface side (upper side in FIG. 4B) of the transponder 20 and a back surface layer 23y located on the back surface side (lower side in FIG. 4B) of the transponder 20. Each of the top surface layer 23x and the back surface layer 23y may be formed of a plurality of layers. The top surface layer 23x and the back surface layer 23y are separated from each other in the thickness direction of the coating layer 23 with the center line of the transponder 20 as a boundary: Positions of end portions of the top surface layer 23x and the back surface layer 23y do not coincide with each other, in other words, a width Wx of the top surface layer 23x and a width Wy of the back surface layer 23y are different from each other. Additionally, in addition to the end portions in the width direction of the coating layer 23, the step 24 may be formed such that the end positions at least on one side of both end portions 23c and 23d in the longitudinal direction of the coating layer 23 do not coincide on both surfaces of the coating layer 23. In other words, the step 24 is a portion where the positions of the end portions 23a to 23d in the width direction and/or the longitudinal direction of the coating layer 23 are shifted on both the top and back surfaces of the coating layer 23. The length direction of the coating layer 23 is the extension direction of the transponder 20 and the width direction of 20) the coating layer 23 is a direction orthogonal to the extension direction of the transponder 20.

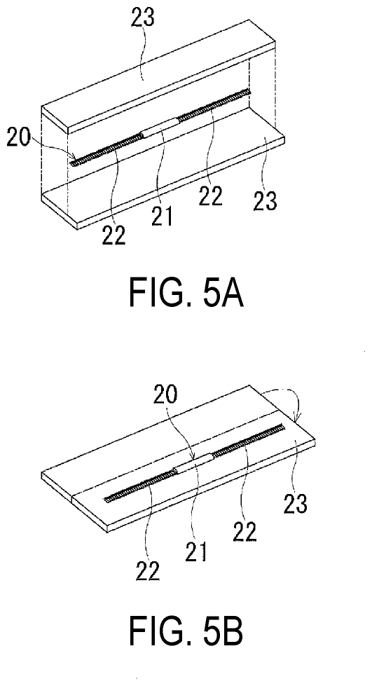

For example, when the coating layer 23 having the cross-sectional shape illustrated in FIGS. 4A and 4B is formed in forming process of forming the step 24 in the coating layer 23, the two coating layers 23 having different widths and a rectangular cross-sectional shape as illustrated in FIG. 5A are used and layered such that end portions in the width direction on one side of the coating layers 23 coincide with each other to cover the entire transponder 20. This can form the step 24 at an end portion in the width direction on the other side of the layered coating layers 23. In this case, the number of layers constituting the coating layer 23 can be arbitrarily set. As illustrated in FIG. 5B, the single coating layer 23 having a rectangular cross-sectional shape may be used, and the coating layer 23 may be folded to cover the entire transponder 20. This can form the step 24 at an end portion in the width direction on one side of the coating layer 23. As another method (not illustrated), the step 24 may be formed by using the two coating layers 23 having the same width and a rectangular cross-sectional shape, layering the coating layers 23 to cover the entire transponder 20, and then removing an end portion at least on one side in the width direction of the layered coating layers 23.

In the method for producing a pneumatic tire described above, causing the coating layer 23 coating the transponder 20 to have, in the thickness direction thereof, the top surface layer 23x located on the top surface side of the transponder 20 and the back surface layer 23y located on the back surface side of the transponder 20, forming the step 24 at least at an end portion on one side of the both end portions 23a and 23b of the coating layer 23 in the width direction such that the positions of end portions of the top surface layer 23x and the back surface layer 23y do not coincide with each other, embedding the transponder 20 coated with the coating layer 23 having the step 24 in the unvulcanized tire, and vulcanizing the unvulcanized tire allows a gap generated between the coating layer 23 and a rubber member (for example, the innerliner layer 9) disposed adjacent to the coating layer 23 to be reduced by the step 24. This can suppress vulcanization defects of the tire around the transponder 20.

On the other hand, using a transponder coated with a coating layer having no step causes a level difference to be locally formed on the circumference of the unvulcanized tire, generates a gap around the transponder between the coating layer and a rubber member disposed adjacent to the coating layer, and causes vulcanization defects of the tire to be likely to occur. In this case, the transponder disposed on an outer side in the tire width direction from the carcass layer causes air to be entrained and cracking to be likely to occur around the transponder. On the other hand, the transponder disposed on an inner side in the tire width direction from the carcass layer causes a projection toward an inner side in the tire radial direction and thus causes release agent to be entrained and cracking to be likely to occur around the transponder.

In the method for producing a pneumatic tire described above, the step 24 is preferably formed by shifting the positions of end portions of the top surface layer 23x and the back surface layer 23y at least at the end portion on the one side of both end portions 23a and 23b in the width direction of the coating layer 23 in sandwiching the transponder 20 between the top surface layer 23x and the back surface layer 23y. For example, using two extruders and disposing the band-like top surface layer 23x and the band-like back surface layer 23y extruded from the respective extruders on the top and back surfaces of the transponder 20 can cover the entire transponder 20. In this case, the widths of the top surface layer 23x and the back surface layer 23y extruded from the respective extruders are different from each other, and the positions of end portions of the top surface layer 23x and the back surface layer 23y are disposed to be shifted in the width direction. This can form the step 24 at least at an end portion on one side of both end portions 23a and 23b of the coating layer 23 in the width direction. Coating the transponder 20 in this manner allows vulcanization defects of the tire to be effectively suppressed.

In particular, the step 24 is preferably formed at both end portions in the width direction of the coating layer 23. Providing the step 24 on the coating layer 23 in this manner can further reduce a gap between the coating layer 23 and a rubber member disposed adjacent to the coating layer 23, thus allowing vulcanization defects of the tire to be effectively suppressed.

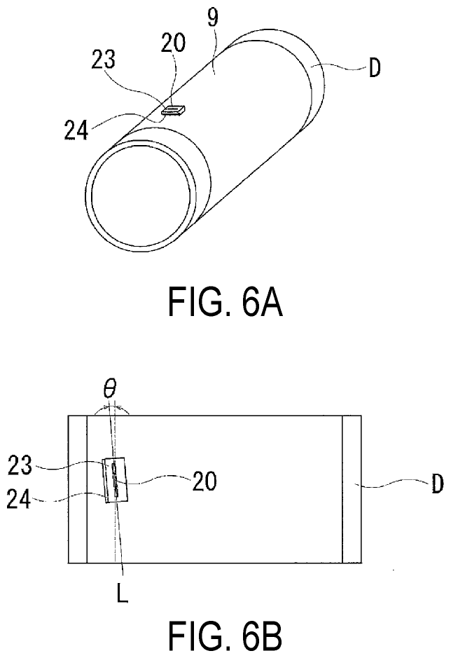

In disposing the transponder 20 coated with the coating layer 23 having the step 24 on a forming drum D, the transponder 20 is preferably disposed such that the longitudinal direction of the transponder 20 is in the range of ±10° with respect to the circumferential direction of the forming drum D as illustrated in FIGS. 6A and 6B. In other words, the illustrated inclination angle θ preferably ranges from −10° to 10°. The inclination angle θ is an angle formed by the circumferential direction of the forming drum D and a center line L of the entire transponder 20. In particular, when both surfaces of the coating layer 23 have different widths, one of the surfaces of the coating layer 23 (for example, the back surface layer 23y illustrated in FIG. 4B), which has a wider width is preferably disposed on the carcass layer 4 side. Disposing the transponder 20 on the forming drum D in this manner can effectively improve tire durability.

In the method for producing a pneumatic tire described above. Mooney viscosity of the coating layer 23 is preferably lower than Mooney viscosity of a rubber member disposed adjacent to the coating layer 23. Examples of such an adjacent rubber member may include the carcass layer 4, the bead filler 6, the innerliner layer 9, the sidewall rubber layer 12, and the rim cushion rubber layer 13. A ratio of Mooney viscosity [ML (1+4) 100° C.] of the coating layer 23 to Mooney viscosity [ML (1+4) 100° C.] of the adjacent rubber member preferably ranges from 0.3 to 0.9, more preferably from 0.5 to 0.8, and most preferably from 0.5 to 0.7. In an embodiment of the present technology, the Mooney viscosity [ML (1+4) 100° C.] is measured in accordance with JIS (Japanese Industrial Standard) K6300-1, by a Mooney viscometer using an L-shaped rotor, and under conditions of preheating time of 1 minute, rotation time of rotor of 4 minutes, and test temperature of 100° C. Appropriately setting the Mooney viscosity of the coating layer 23 with respect to the adjacent rubber member in this manner makes the rubber flow of the coating layer 23 during vulcanization satisfactory and causes vulcanization defects to be less likely to occur even when a gap is generated between the coating layer 23 and the adjacent rubber member.

Here, the ratio of the Mooney viscosity of the coating layer 23 to the Mooney viscosity of the adjacent rubber member of smaller than 0.3 makes the rubber flow of the coating layer 23 during vulcanization excessively good, may expose the transponder 20, and degrades communication performance of the transponder 20 when the transponder 20 comes into contact with the adjacent rubber member. On the other hand, the ratio of the Mooney viscosity of the coating layer 23 to the Mooney viscosity of the adjacent rubber member of larger than 0.9 degrades the rubber flow of the coating layer 23 during vulcanization, causes a gap to be likely to be generated between the coating layer 23 and the adjacent rubber member, and thus causes vulcanization defects of the tire to be likely to occur.

Additionally, the minimum value M_{Lc} on a vulcanization curve obtained from torque detection by using a rheometer in the coating layer 23 is preferably smaller than the minimum value M_{Lt} on a vulcanization curve obtained from torque detection by using the rheometer in the rubber member disposed adjacent to the coating layer 23. It is more preferable that the minimum value M_{Lc} of the coating layer 23 and the minimum value M_{Lt} of the adjacent rubber member satisfy the relationship 0.2≤M_{Lc}/M_{Lt}<1.0. Appropriately setting the viscosity of the coating layer 23 in this manner makes the rubber flow of the coating layer 23 during vulcanization satisfactory and causes a gap to be less likely to be generated between the coating layer 23 and the adjacent rubber member, thus allowing vulcanization defects of the tire to be effectively suppressed. In an embodiment the present technology, the vulcanization curve obtained from torque detection by using the rheometer is in accordance with JIS K6300-2 and is obtained by measuring, at a temperature of 170° C. a vulcanization curve having the torque to be obtained on the vertical axis and the vulcanization time on the horizontal axis. The minimum value of torque is M_{L} in the vulcanization curve.

Here, the minimum value M_{Lc} of the coating layer 23 and the minimum value M_{Lt} of the adjacent rubber member of lower than the lower limit of the relational expression described above makes the rubber flow of the coating 35 layer 23 during vulcanization excessively good, may expose the transponder 20, and degrades communication performance of the transponder 20 when the transponder 20 comes into contact with the adjacent rubber member. On the other hand, the minimum value M_{Lc} of the coating layer 23 and the minimum value M_{Lt} of the adjacent rubber member exceeding the upper limit of the relational expression described above degrades the rubber flow of the coating layer 23 during vulcanization, causes a gap to be likely to be generated between the coating layer 23 and the adjacent rubber member, and thus causes vulcanization defects of the tire to be likely to occur.

In the method for producing a pneumatic tire described above, a width w of the step 24 (see FIG. 4B) preferably ranges from 1.5 mm to 5.0 mm. The width w of the step is an average value of widths measured at a total of three points of both end portions in the longitudinal direction of the coating layer 23 and the center of the coating layer 23. Appropriately setting the width w of the step in this manner can effectively suppress vulcanization defects of the tire and improve tire durability.

Here, the width w of the step smaller than 1.5 mm cannot sufficiently obtain the effect of improving vulcanization defects of the tire, degrading tire durability due to the vulcanization defects of the tire. The width w of the step larger than 5.0 mm increases the gap between the coating layer 23 and the adjacent rubber member, thus failing to sufficiently obtain the effect of improving vulcanization defects of the tire and degrading tire durability due to the vulcanization defects of the tire.

A thicknesses t (see FIG. 4B) of at least one of the top surface layer 23x or the back surface layer 23y preferably ranges from 0.5 mm to 2.5 mm. The thicknesses t of the coating layer 23 is a thickness measured by dividing the coating layer 23 in the thickness direction with respect to the center line of the transponder 20 as a boundary, i.e., the thicknesses of the top surface layer 23x or the thickness of the back surface layer 23y. A thickness of the coating layer 23 formed of three or more layers is also measured as described above.

Here, the thickness t of the coating layer 23 smaller than 0.5 mm degrades the communication performance of the transponder 20 but allows vulcanization defects of the tire around the transponder 20 to be suppressed. The thickness t of the coating layer 23 greater than 2.5 mm improves the communication performance of the transponder 20 but causes vulcanization defects of the tire to be likely to occur. Setting the thickness t of the coating layer 23 within the range described above can effectively suppress vulcanization defects of the tire.

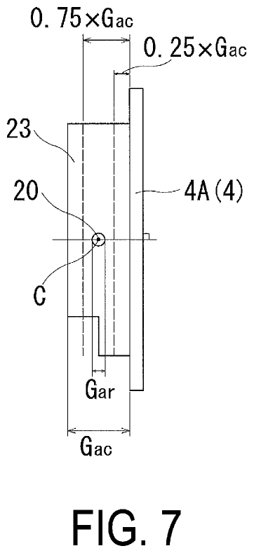

In the method for producing a pneumatic tire described above, the relative dielectric constant of the coating layer 23 coating the transponder 20 is set to be lower than the relative dielectric constant of the rubber member (for example, the innerliner layer 9, the bead filler 6, the sidewall rubber layer 12, the rim cushion rubber layer 13, or the coating rubber of the carcass layer 4) disposed adjacent to the coating layer 23, and a total thickness Gac of the coating layer 23 and the maximum thickness Gar of the transponder 20 preferably satisfy the relationship 1.1≤Gac/Gar≤3.0. The total thickness Gac of the coating layer 23 is the total thickness of the coating layer 23 at a position including the transponder 20, and is, for example, as illustrated in FIG. 7, the total thickness on a straight line passing through the center C of the transponder 20 and orthogonal to the carcass cord of the closest carcass layer 4 in a tire meridian cross-section.

Setting the relative dielectric constant of the coating layer 23 in this manner and allowing the total thickness Gac of the coating layer 23 and the maximum thickness Gar of the transponder 20 to satisfy the relationship described above causes the transponder 20 to be sufficiently isolated from the adjacent rubber member and to be wrapped with the coating layer 23 having a low relative dielectric constant, thus allowing the communication performance of the transponder 20 to be improved. In other words, the wavelength of the radio wave of a communication device is λ, the relative dielectric constant of the coating layer 23 covering the transponder 20 is εᵣ, the wavelength of the radio wave passing through the coating layer 23 is λ/√εᵣ, and thus the length of the antenna 22 of the transponder 20 is set so as to resonate with the wavelength λ/√εᵣ. Optimizing the length of the antenna 22 of the transponder 20 in this way significantly improves communication efficiency. However, the transponder 20 needs to be sufficiently isolated from the adjacent rubber member adjacent to the coating layer 23 in order to optimize the communication environment of the transponder 20. Satisfying the relationship 1.1≤Gac/Gar≤3.0 can improve the communication performance of the transponder 20. Further, specifying the upper limit value of the total thickness Gac of the coating layer 23 with respect to the maximum thickness Gar of the transponder 20 can ensure sufficient durability of the tire. This can provide the improved communication performance of the transponder 20 while ensuring the durability of the tire.

Here, when the aforementioned ratio is excessively small (the total thickness Gac of the coating layer 23 is excessively thin), the transponder 20 comes into contact with the adjacent rubber member, resonant frequency is shifted, and the communication performance of the transponder 20 is degraded. On the other hand, when the aforementioned ratio is excessively large (the total thickness Gac of the coating layer 23 is excessively thick), tire durability tends to be degraded.

As illustrated in FIG. 7, in the method for producing a pneumatic tire described above, the center C of the transponder 20 in the thickness direction is preferably disposed within a range of from 25% to 75% of the total thickness Gac of the coating layer 23 from the surface on one side of the coating layer 23 in the thickness direction. This allows the transponder 20 to be reliably coated with the coating layer 23, thus stabilizes the surrounding environment of the transponder 20, causes no shifting of the resonant frequency, and can have sufficient communication distance of the transponder 20.

As the composition of the coating layer 23, the coating layer 23 is preferably made of rubber or elastomer and 20 phr or more of white filler. The relative dielectric constant can be set relatively lower for the coating layer 23 configured as described above than for the coating layer 23 containing carbon, allowing the communication performance of the transponder 20 to be effectively improved. The “phr” as used herein means parts by weight per 100 parts by weight of the rubber component (elastomer).

The white filler constituting the coating layer 23 preferably includes from 20 phr to 55 phr of calcium carbonate. This enables a relatively low relative dielectric constant to be set for the coating layer 23, allowing the communication performance of the transponder 20 to be effectively improved. However, the white filler with an excessive amount of calcium carbonate contained is brittle, and the strength of the coating layer 23 decreases. This is not preferable. The coating layer 23 can optionally contain, in addition to calcium carbonate, 20 phr or less of silica (white filler) or 5 phr or less of carbon black. In a case where a small amount of silica or carbon black is used with the coating layer 23, the relative dielectric constant of the coating layer 23 can be reduced while ensuring the strength of the coating layer 23.

The coating layer 23 preferably has a relative dielectric constant of 7 or less and more preferably from 2 to 5. Appropriately setting the relative dielectric constant of the coating layer 23 in this manner allows radio wave transmittivity when the transponder 20 emits a radio wave to be ensured, effectively improving the communication performance of the transponder 20. The rubber constituting the coating layer 23 has a relative dielectric constant of from 860 MHz to 960 MHz at ambient temperature. Here, the ambient temperature is 23±2° C. and 60%±5% RH (relative humidity) in accordance with the standard conditions of the JIS standard. The relative dielectric constant of the rubber is measured by the capacitance method after the rubber is treated at 23° C. and 60% RH for 24 hours. The range of from 860 MHz to 960 MHZ described above corresponds to currently allocated frequencies of the RFID in a UHF (ultra-high frequency) band, but in a case where the allocated frequencies are changed, the relative dielectric constant in the range of the allocated frequencies may be specified as described above.

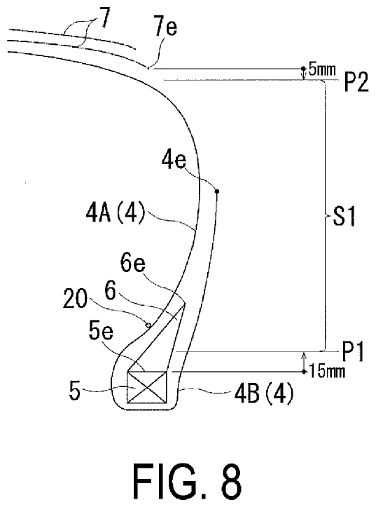

In the method for producing a pneumatic tired described above, as a placement region in the tire radial direction, the transponder 20 is preferably disposed between a position P1 15 mm on an outer side in the tire radial direction from an upper end 5e of the bead core 5 (an end portion on the outer side in the tire radial direction) and a position P2 5 mm on an inner side in the tire radial direction from an end 7e of the belt layer 7. In other words, the transponder 20 is preferably disposed in a region S1 illustrated in FIG. 8. Disposing the transponder 20 in the region S1 causes metal interference to be unlikely to occur and can have the communication performance of the transponder 20. Here, disposing the transponder 20 on an inner side of the position P1 in the tire radial direction causes the transponder 20 to be easily peeled off from the adjacent rubber member due to stress concentration near the rim flange and the transponder 20 to be brought close to a metal member such as the bead core 5 and thus causes the communication performance of the transponder 20 to tend to be degraded. On the other hand, disposing the transponder 20 on an outer side of the position P2 in the tire radial direction causes the transponder 20 to be located in a region where a stress amplitude is larger during travel and thus causes a damage of the transponder 20 itself and an interfacial failure around the transponder 20 to be likely to occur.

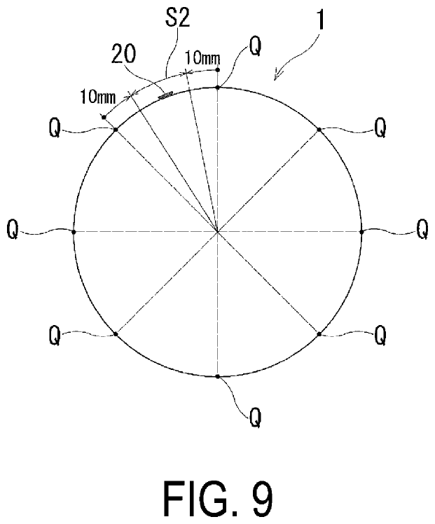

As illustrated in FIG. 9, a plurality of splice portions formed by overlaying end portions of the tire components are on the tire circumference. FIG. 9 illustrates positions Q of the respective splice portions in the tire circumferential direction. The center of the transponder 20 is preferably disposed 10 mm or more away from the splice portions of the tire components in the tire circumferential direction. In other words, the transponder 20 is preferably disposed in a region S2 illustrated in FIG. 9. Specifically, the substrate 21 constituting the transponder 20 is preferably separated 10 mm or more from the position Q in the tire circumferential direction. Furthermore, the entire transponder 20 including the antenna 22 is more preferably separated 10 mm or more from the position Q in the tire circumferential direction, and the entire transponder 20 coated with the coating rubber is most preferably separated 10 mm or more from the position Q in the tire circumferential direction. The tire component in which the splice portion is disposed away from the transponder 20 is preferably a member adjacent to the transponder 20. Examples of such tire components include the carcass layer 4, the bead filler 6, the belt layer 7, the innerliner layer 9, the cap tread rubber layer 11, the sidewall rubber layer 12, and the rim cushion rubber layer 13. Disposing the transponder 20 away from the splice portions of the tire components as described above can effectively improve tire durability.

In an example illustrated in the embodiment of FIG. 9, the positions Q of the splice portions of each tire component in the tire circumferential direction are disposed at equal intervals, but no such limitation is intended. The position Q in the tire circumferential direction can be set at any position, and in either case, the transponder 20 is disposed 10 mm or more away from the splice portion of each tire component in the tire circumferential direction.

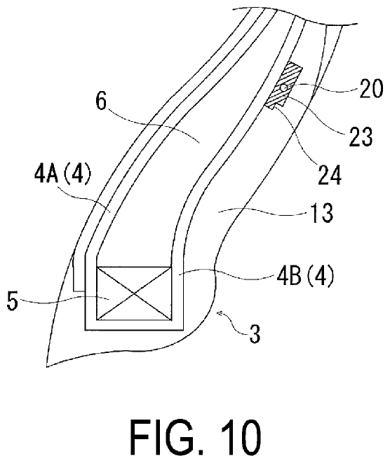

FIG. 10 illustrates a modified example of a pneumatic tire to which the method for producing a pneumatic tire according to an embodiment of the present technology is applied. In FIG. 10, components that are identical to those in FIGS. 1 and 2 are denoted by the same reference signs, and detailed descriptions of those components will be omitted.

As illustrated in FIG. 10, the transponder 20 is embedded in a portion on an outer side of the carcass layer 4 in the tire width direction. Specifically, the transponder 20 is disposed between the turned-up portion 4B of the carcass layer 4 and the rim cushion rubber layer 13. In producing a pneumatic tire in which the transponder 20 is embedded in a portion on an outer side of the carcass layer 4 in the tire width direction in this manner, the pneumatic tire is produced by placing the innerliner layer 9 on a forming drum, layering thereon the tire components including the carcass layer 4, the bead core 5, the bead filler 6, the belt layer 7, and the belt cover layer 8, bonding the cap tread rubber layer 11, the sidewall rubber layer 12, and the rim cushion rubber layer 13 to form an unvulcanized tire, and vulcanizing the unvulcanized tire. In forming the unvulcanized tire, the transponder 20 coated with the coating layer 23 is disposed, for example, between the carcass layer 4 and the sidewall rubber layer 12 or the rim cushion rubber layer 13. Even the method for producing a pneumatic tire described above allows a gap generated between the coating layer 23 and a rubber member (for example, the sidewall rubber layer 12, the rim cushion rubber layer 13, or the like) disposed adjacent to the coating layer 23 to be reduced by the step 24. This can suppress vulcanization defects of the tire around the transponder 20.

In an example illustrated in the embodiment of FIG. 10, the transponder 20 is disposed between the turned-up portion 4B of the carcass layer 4 and the rim cushion rubber layer 13, but no such limitation is intended. The transponder 20 can also be disposed between the body portion 4A of the carcass layer 4 and the sidewall rubber layer 12. The end 4e of the turned-up portion 4B of the carcass layer 4 may be disposed in the middle of the sidewall portion 2. Alternatively, the end 4e of the turned-up portion 4B of the carcass layer 4 may be disposed on a side of the bead core 5. In such a low turn-up structure, the transponder 20 can be disposed between the bead filler 6 and the sidewall rubber layer 12 or the rim cushion rubber layer 13.

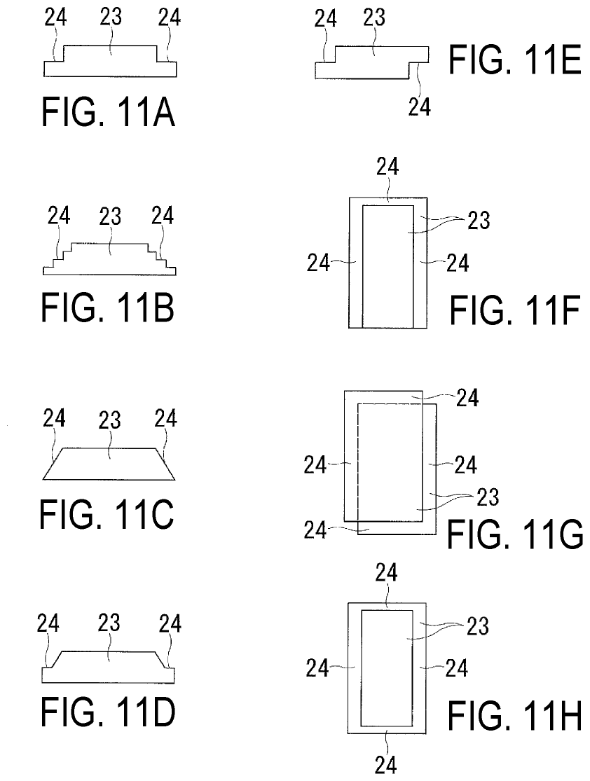

In an example illustrated in the embodiment described above, the step 24 is formed only at the end portion on one side of the coating layer 23 in the width direction, but no such limitation is intended. In forming the step 24, as illustrated in FIG. 11A, the step 24 can be formed at each of both end portions in the width direction of the coating layer 23. As illustrated in FIG. 11B, the step 24 having a plurality of steps can be formed at each of both end portions of the coating layer 23 in the width direction. As illustrated in FIG. 11C, the step 24 formed of inclined surfaces can be formed at each of both end portions of the coating layer 23 in the width direction. As illustrated in FIG. 11D, the step 24 with an inclined surface and a flat surface combined can be formed at each of both end portions of the coating layer 23 in the width direction. Further, these shapes can be combined, and the step 24 having an asymmetrical shape can be disposed on each of both sides of the coating layer 23 in the width direction.

In forming the step 24, as illustrated in FIG. 11E, steps 24 can be formed by shifting the positions of the end portions in the width direction of the two coating layers 23 having the same width. As illustrated in FIG. 11F, the steps 24 can be formed not only at the end portions in the width direction of the coating layer 23 but also at the end portion on one side in the longitudinal direction of the coating layer 23. As illustrated in FIGS. 11G and 11H, the steps 24 can be formed at both end portions of the coating layer 23 in the width direction and at both end portions of the coating layer 23 in the longitudinal direction.

### EXAMPLES

In a method for producing a pneumatic tire having a tire size of 245/35R21 in which a transponder is embedded, tires of Conventional Example and Examples 1 to 13 were produced. For each of the tires, a transponder was coated with a coating layer, the transponder coated with the coating layer was embedded in an unvulcanized tire, and the unvulcanized tire was vulcanized. The presence or absence of a step of the coating layer, the width of the step of the coating layer, Gac/Gar, the material of the coating layer, the relative dielectric constant of the coating layer, the position of the transponder in the tire circumferential direction, and the position of the transponder in the tire radial direction were set as shown in Table 1.

In Conventional Example and Examples 1 to 13, the transponder is embedded between the carcass layer and the innerliner layer, and the relative dielectric constant of the coating layer coating the transponder is set to be lower than that of a rubber member (the innerliner layer and coating rubber of the carcass layer) disposed adjacent to the coating layer.

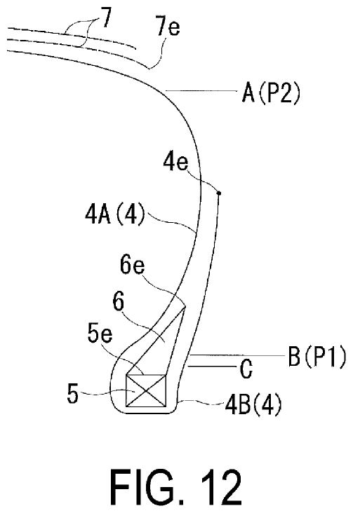

In Table 1, the position of the transponder in the tire circumferential direction indicates the distance (mm) measured from the center of the transponder to the splice portion of the tire component in the tire circumferential direction. The position of the transponder in the tire radial direction corresponds to each of the positions A to C illustrated in FIG. 12.

Tire evaluations (vulcanization defects and durability) and transponder evaluation (communication performance) were conducted on these test tires in accordance with the following test methods, and the results are shown in Table 1.

### Vulcanization Defects:

Two hundred tires were produced for each test tire, and the occurrence of vulcanization defects around the transponder was visually confirmed to calculate the rate of occurrence of vulcanization defects. The evaluation results are expressed in three levels: “Excellent” indicates no vulcanization defects, “Good” indicates the rate of occurrence of vulcanization defects of less than 3%, and “Fair” indicates the rate of occurrence of vulcanization defects of 3% or more.

### Durability (Tire):

Each of the test tires was mounted on a wheel of a standard rim, and a traveling test was performed by using a drum testing machine at an air pressure of 120 kPa, 102% of the maximum load, and a traveling speed of 81 km/h. After the test was performed, the traveling distance at the time of occurrence of a failure in the tire was measured. Evaluation results are expressed in three levels: “Excellent” indicates that the traveling distance reached 6480 km, “Good” indicates that the traveling distance was 4050 km or more and less than 6480 km, and “Fair” indicates that the traveling distance was less than 4050 km.

### Communication Performance (Transponder):

For each test tire, a communication operation with the transponder was performed using a reader/writer. Specifically, the maximum communication distance was measured with the reader/writer at a power output of 250 mW and a carrier frequency of from 860 MHz to 960 MHz. The evaluation results are expressed in three levels: “Excellent” indicates that the communication distance is 1000 mm or more, “Good” indicates that the communication distance is 500 5 mm or more and less than 1000 mm, and “Fair” indicates that the communication distance is less than 500 mm.

TABLE 1
1, 2 & 3

| | | Conventional | Example | Example | Example |
|---|---|---|---|---|---|
| | | Example | 1 | 2 | 3 |
| Presence of step of coating layer | | No | Yes | Yes | Yes |
| Width of step of coating layer (mm) | | 1.0 | 1.0 | 1.5 | 5.0 |
| Gac/Gar | | 1.0 | 1.0 | 1.0 | 1.0 |
| Material of coating layer | | Resin | Resin | Resin | Resin |
| Relative dielectric constant of | | 8 | 8 | 8 | 8 |
| coating layer | | | | | |
| Position of transponder in tire | | 10 | 10 | 10 | 10 |
| circumferential direction (mm) | | | | | |
| Position of transponder in tire radial | | A | A | A | A |
| direction | | | | | |
| Tire evaluation | Vulcanization defects | Fair | Good | Excellent | Excellent |
| | Durability | Fair | Good | Excellent | Excellent |
| Transponder | Communication | Fair | Fair | Fair | Fair |
| evaluation | performance | | | | |

1, 2 & 3

| | | Example | Example | Example | Example | Example |
|---|---|---|---|---|---|---|
| | | 4 | 5 | 6 | 7 | 8 |
| Presence of step of coating layer | | Yes | Yes | Yes | Yes | Yes |
| Width of step of coating layer (mm) | | 5.5 | 1.5 | 1.5 | 1.5 | 1.5 |
| Gac/Gar | | 1.0 | 1.1 | 2.0 | 3.0 | 3.1 |
| Material of coating layer | | Resin | Resin | Resin | Resin | Resin |
| Relative dielectric constant of | | 8 | 8 | 8 | 8 | 8 |
| coating layer | | | | | | |
| Position of transponder in tire | | 10 | 10 | 10 | 10 | 10 |
| circumferential direction (mm) | | | | | | |
| Position of transponder in tire | | A | A | A | A | A |
| radial direction | | | | | | |
| Tire | Vulcanization | Good | Excellent | Excellent | Excellent | Good |
| evaluation | defects | | | | | |
| | Durability | Good | Excellent | Excellent | Good | Fair |
| Transponder | Communication | Fair | Good | Excellent | Excellent | Good |
| evaluation | performance | | | | | |

1, 2 & 3

| | | Example | Example | Example | Example | Example |
|---|---|---|---|---|---|---|
| | | 9 | 10 | 11 | 12 | 13 |
| Presence of step of coating layer | | Yes | Yes | Yes | Yes | Yes |
| Width of step of coating layer (mm) | | 1.5 | 1.5 | 1.5 | 1.5 | 1.5 |
| Gac/Gar | | 1.0 | 1.0 | 1.0 | 1.0 | 1.0 |
| Material of coating layer | | Rubber | Rubber | Rubber | Rubber | Rubber |
| Relative dielectric constant of | | 8 | 7 | 7 | 7 | 7 |
| coating layer | | | | | | |
| Position of transponder in tire | | 10 | 10 | 5 | 10 | 10 |
| circumferential direction (mm) | | | | | | |
| Position of transponder in tire | | A | A | A | B | C |
| radial direction | | | | | | |
| Tire | Vulcanization | Excellent | Excellent | Excellent | Excellent | Excellent |
| evaluation | defects | | | | | |
| | Durability | Excellent | Excellent | Good | Excellent | Good |
| Transponder | Communication | Good | Excellent | Excellent | Excellent | Good |
| evaluation | performance | | | | | |

As can be seen from Table 1, the pneumatic tires of Examples 1 to 13 5 were able to suppress the occurrence of vulcanization defects of the tire as compared with the Conventional Example. Additionally, the pneumatic tires of Examples 1 to 7 and 9 to 13 were able to provide improved durability of the tire as compared with Conventional Example, and the pneumatic tires of Examples 5 to 13 were able to provide improved communication performance of the transponder as compared with Conventional Example.

1-12. (canceled)

13. A method for producing a pneumatic tire for embedding a transponder, the method comprising:
causing a coating layer coating the transponder to have, in a thickness direction thereof, a top surface layer located on a top surface side of the transponder and a back surface layer located on a back surface side of the transponder;
forming a step at least at an end portion on one side of both end portions of the coating layer in a width direction such that positions of end portions of the top surface layer and the back surface layer do not coincide with each other;
embedding the transponder coated with the coating layer having the step in an unvulcanized tire; and
vulcanizing the unvulcanized tire.

14. The method for producing a pneumatic tire according to claim 13, wherein the step is formed by shifting the positions of end portions of the top surface layer and the back surface layer at least at the end portion on the one side of both end portions of the coating layer in the width direction in sandwiching the transponder between the top surface layer and the back surface layer.

15. The method for producing a pneumatic tire according to claim 13, wherein the step is formed at each of both end portions of the coating layer in the width direction.

16. The method for producing a pneumatic tire according to claim 13, wherein a width of the step ranges from 1.5 mm to 5.0 mm.

17. The method for producing a pneumatic tire according to claim 13, wherein a thickness of at least one of the top surface layer or the back surface layer ranges from 0.5 mm to 2.5 mm.

18. The method for producing a pneumatic tire according to claim 13, wherein
a relative dielectric constant of the coating layer is lower than a relative dielectric constant of a rubber member disposed adjacent to the coating layer, and
a total thickness Gac of the coating layer and a maximum thickness Gar of the transponder satisfy a relationship 1.1≤Gac/Gar≤3.0.

19. The method for producing a pneumatic tire according to claim 13, wherein the coating layer is made of elastomer or rubber and has a relative dielectric constant of 7 or less.

20. The method for producing a pneumatic tire according to claim 13, wherein Mooney viscosity of the coating layer is lower than Mooney viscosity of a rubber member disposed adjacent to the coating layer.

21. The method for producing a pneumatic tire according to claim 13, wherein a minimum value M_{Lc} on a vulcanization curve obtained from torque detection by using a rheometer in the coating layer is lower than a minimum value M_{Lt} on a vulcanization curve obtained from torque detection by using the rheometer in a rubber member disposed adjacent to the coating layer.

22. The method for producing a pneumatic tire according to claim 13, wherein the transponder is disposed such that a longitudinal direction of the transponder is within a range of ±10° with respect to a circumferential direction of a forming drum.

23. The method for producing a pneumatic tire according to claim 13, wherein a center of the transponder is disposed 10 mm or more away from a splice portion of a tire component in a tire circumferential direction.

24. The method for producing a pneumatic tire according to claim 13, wherein the transponder is disposed between a position 15 mm on an outer side in a tire radial direction from an upper end of a bead core of a bead portion and a position 5 mm on an inner side in the tire radial direction from an end of a belt layer.
